(19) United States
(12) Patent Application Publication
(10) Pub. No.: US 2010/0182908 A1
(43) Pub. Date: Jul. 22, 2010

(54) TRAFFIC CONTROL METHOD FOR IPTV BROADCASTING SERVICE

(76) Inventors: Young Min Kim, Seoul (KR); Chang Ho Lee, Uiwang-si (KR)

Correspondence Address: PARK LAW FIRM, 3255 WILSHIRE BLVD, SUITE 1110, LOS ANGELES, CA, 90010, US

(21) Appl. No.: 12/663,909

(22) PCT Filed: Jun. 12, 2008
(86) PCT No.: PCT/KR2008/003282

§ 371 Date: Dec. 10, 2009

(30) Foreign Application Priority Data
Jun. 18, 2007 (KR) 1020070059293

(51) Int. Cl. H04J 1/16; H04N 7/173

(52) U.S. Cl. 370/235; 725/110

(57) ABSTRACT

Provided is a traffic control method of IPTV broadcast service that allows a broadcast server to transmit data in a maximum bandwidth. The broadcast server sets a maximum buffer amount. The broadcast server monitors a network state to transmit data in a maximum bandwidth allowed by a network. The broadcast server judges whether a buffer amount of transmitted data reaches a maximum buffer amount. When the buffer amount of transmitted data reaches the maximum buffer amount, the broadcast server controls a bandwidth depending on a reproduction speed of a set-top box (STB) to transmit data. When the buffer amount of transmitted data does not reach the maximum buffer amount, the broadcast server transmits data in a maximum bandwidth allowed by the network.

### TECHNICAL FIELD

The present invention relates to data transmission technology for an Internet protocol television (IPTV), and more particularly, to traffic control method for IPTV broadcasting service that allows a set-top box (STB) to stably play contents without a delay regardless of a network state by allowing a broadcast server to variably control a data transmission amount to the STB and thus maintain a constant buffer amount of the STB.

### BACKGROUND ART

Generally, an IPTV is defined as multimedia service such as television, video, audio, text, graphic, and data services provided through an IP network guaranteeing quality, security, and reliability. The IPTV includes live TV service transmitted in a multicast method, and stored video service such as a video-on-demand (VOD) transmitted in a unicast method.

Generally, an IPTV system includes a broadcast server transmitting contents (programs) on an IP network, and an IPTV STB receiving contents from the IP network to reproduce the received contents. A video signal transmitted through the IP network is a bit stream coded according to a compression method such as a moving picture experts group 2 (MPEG2) and an MPEG4. In the live TV service, a user can access a multicast stream according to an Internet group management protocol version 2 (IGMPv2) to view broadcasting. In the VOD service, a user can view video contents in a unicast method according to a real-time streaming protocol (RTSP).

Meanwhile, a broadcast server of a conventional IPTV always transmits data in a predetermined bandwidth when transmitting contents to an STB, and the STB receives the data to buffer and play the data. Therefore, the data transmission of the broadcast server and the buffering and playing of the STB are performed swiftly on the assumption that a network state is good. That is, for example, in the case where it takes 3 seconds for the STB to buffer and play data transmitted from the broadcast server, the broadcast server and the STB continuously transmit and play the data (contents) with a delay interval of 3 seconds. A traffic control method in the conventional IPTV broadcast service is illustrated in FIG. 9.

As illustrated in FIG. 9, in the conventional IPTV broadcast service, a STB 200 checks its reception buffer and requests a broadcast server 100 to transmit data (contents) when there is a space in the reception buffer (S1, S2, and S4). When a transmission request is received from the STB 200, the broadcast server 100 transmits data (contents) in a predetermined bandwidth (S6 and S7). Meanwhile, when there is no space in the reception buffer of the STB 200 in operation S2, the STB processes data of the reception buffer to standby until a space is secured to some extent, and requests transmission when the space is secured (S5).

As described above, traffic control and buffering are performed primarily for the STB in the conventional IPTV broadcast service. Therefore, even when a network state is good and the broadcast server can transmit a large amount of data in a larger bandwidth, the broadcast server has no choice but to transmit data by only an amount requested by the STB. Therefore, network resources cannot be efficiently used. Also, as the broadcast server always transmits data in a predetermined bandwidth, the STB cannot secure a sufficient amount of buffer. Accordingly, when data transmission amount from the broadcast server reduces due to an unstable network state for example, playing of data is delayed at the STB until a predetermined amount of data is received.

### DISCLOSURE OF INVENTION

### Technical Problem

An object of the present invention is to provide a traffic control method of an IPTV broadcast service that reproduces contents without a delay by setting a target buffer amount, which is a buffer amount that allows a STB to stably reproduce contents without an influence of a network state, and allowing a broadcast server to control traffic and thus variably control a data transmission amount to the STB so that the STB maintains the target buffer amount.

Another object of the present invention is to provide a traffic control method of an IPTV broadcast service that allows a STB to secure a sufficient buffer amount to prevent contents reproduction from being delayed even when a data transmission amount from a broadcast server reduces due to a unstable network by transmitting a maximum amount of data in a maximum bandwidth that is allowed by the broadcast server to secure a buffer amount of the STB by a target buffer amount, and transmitting data again as much as possible when the buffer amount of the STB reduces to continuously maintain the buffer amount of the STB by the target buffer amount.

### Technical Solution

According to an aspect of the present invention, there is provided a traffic control method including: setting, at a broadcast server, a maximum buffer amount; monitoring, at the broadcast server, a network state to transmit data in a maximum bandwidth allowed by a network; judging, at the broadcast server, whether a buffer amount of transmitted data reaches a maximum buffer amount; when the buffer amount of transmitted data reaches the maximum buffer amount, controlling, at the broadcast server, a bandwidth according to a reproduction speed of a set-top box (STB) to transmit data; and when the buffer amount of transmitted data does not reach the maximum buffer amount, transmitting, at the broadcast server, data in a maximum bandwidth allowed by the network.

### ADVANTAGEOUS EFFECTS

As described above, according to the present invention, the broadcast server controls a transmission bandwidth depending on a buffer amount of the STB to variably control a transmission amount of data. Therefore, a traffic control and buffering are made primarily by the broadcast server. When a network state is good, the broadcast server can transmit a large amount of data in a larger bandwidth to increase efficiency. Even when the network state is not good, the STB sufficiently secure data corresponding to the buffer amount in advance to stably reproduce data (contents) without a delay or suspension.

In other words, the broadcast server sets the target buffer amount of the STB and, when the buffer amount of the STB does not reach the target buffer amount, the broadcast server transmits data as much as possible in a maximum bandwidth within a limit allowed by the network, and when the buffer amount of the STB reaches the target buffer amount, the broadcast server transmits data in an appropriate bandwidth by an amount reproduced by the STB, so that network resources (particularly, traffic) can be efficiently used. Also, even when the network state deteriorates and an amount of data transmitted from the broadcast server reduces, the STB buffers already a sufficient amount of data by the target buffer amount, so that the STB can reproduce data (contents) without a delay or suspension.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view of the entire construction of a general IPTV;

FIG. 2 is a view illustrating an example of an IP multicast network for transmitting live contents;

FIG. 3 is a view illustrating an example of an UDP format primarily used in a multicasting;

FIG. 4 is a view illustrating an example of an IGMP format primarily used in a multicasting;

FIG. 5 is a view illustrating an example of a channel setting procedure according to an IGMP;

FIG. 6 is a view illustrating an example of a TCP segment primarily used in a unicast;

FIG. 7 is a view illustrating an example of a channel setting procedure according to an RTSP primarily used in a unicast;

FIG. 8 is a flowchart of a traffic control method in IPTV broadcast service according to the present invention; and

FIG. 9 is a flowchart of a traffic control method in IPTV broadcast service according to a conventional art.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

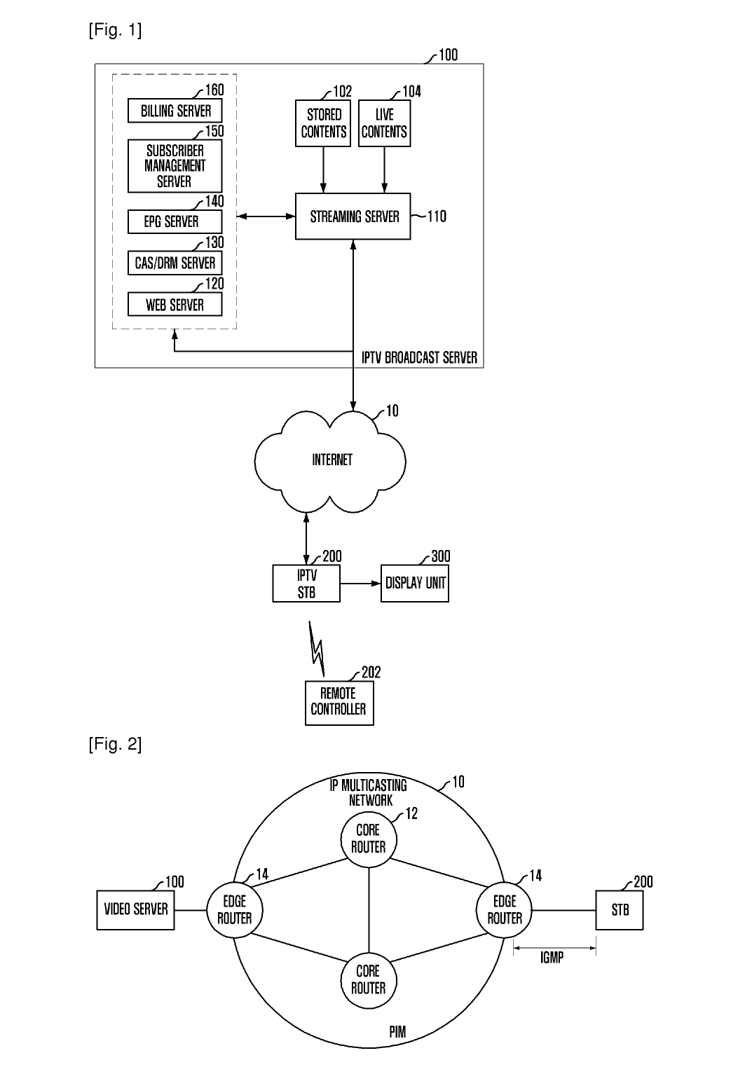

FIG. 1 is a schematic view of the entire construction of a general IPTV. The IPTV includes an IPTV broadcast server 100 providing television broadcast service through the Internet 10, and an IPTV STB 200 connected to the Internet 10 and operating according to a user's manipulation of a remote controller 202 to receive live television broadcast or VOD contents and output the same through a display unit 300.

Referring to FIG. 1, the IPTV broadcast server 100 includes a streaming server 110 providing stored video contents 102 or live contents 104 (TV broadcast program) through the Internet 10, a web server 120 providing web service, a conditional access system/digital right management (CAS/DRM) server 130 protecting contents, an electronic program guide (EPG) server 140 guiding a broadcast program, a subscriber management server 150 managing a subscriber, and a billing server 160 for billing. Here, CAS is an abbreviation of conditional access system, contents security technology allowing only a licensed subscriber to view a relevant channel in a charged TV system, and DRM is an abbreviation of digital right management, contents protection technology preventing illegal copy of contents on the Internet.

The IPTV STB 200 mounts a web browser required for using web service through the Internet 10, and a multimedia reproducer for reproducing a moving image therein. The IPTV STB 200 receives TV broadcast or a web page to output the same to a display unit 300 according to a user manipulation of a remote controller 202. The display unit 300 can be a general cathode ray tube (CRT), a liquid crystal display (LCD), a plasma display panel (PDP), or a monitor.

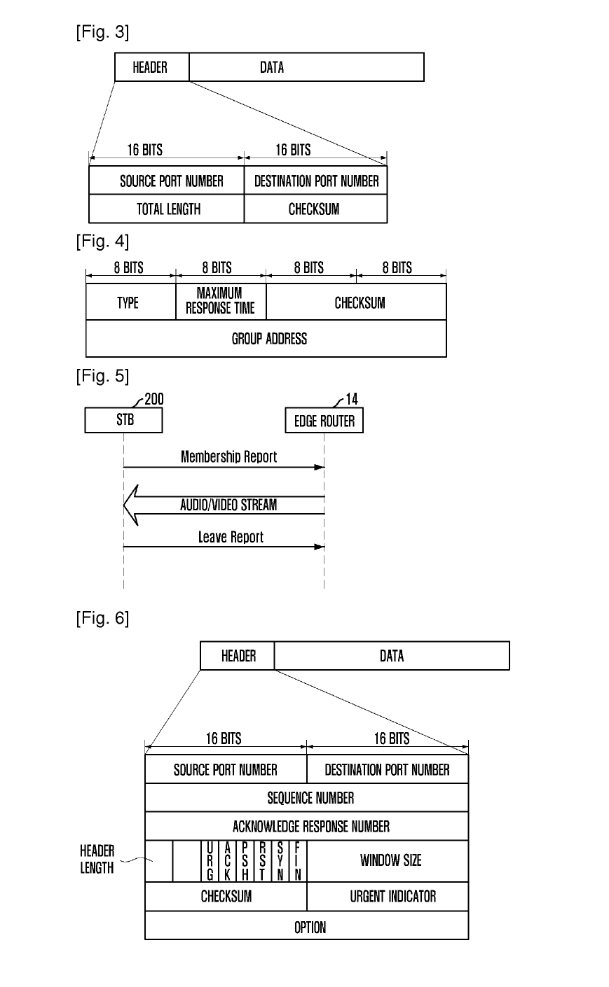

FIG. 2 is a view illustrating an example of an IP multicast network for transmitting live contents, FIG. 3 is a view illustrating an example of a user datagram protocol (UDP) format primarily used in a multicasting, FIG. 4 is a view illustrating an example of an IGMP format primarily used in a multicasting, and FIG. 5 is a view illustrating an example of a channel setting procedure according to an IGMP.

The Internet 10 is a combination of networks connected via routers. When one packet is transferred from a source to a destination, it is transferred through an optimized path. For a transmission method in the Internet 10, there are unicast, multicast, broadcast in case of IPv4, and there are Anycast, unicast, and multicast in case of IPv6. Also, routing is classified into a unicast routing directed from a single source to a different single destination, and a multicast routing directed from one source to a different destination group. Generally, in a general IPTV, live broadcast contents are transmitted in a multicast method, and stored contents are transmitted in a unicast method. Also, the multicast method uses a class D address, and a non-connection type UDP protocol is suitable. A transmission control protocol (TCP), which is connection type service, is suitable for the unicast method.

Referring to FIG. 2, the IP multicast network 10 is realized using edge routers 14 to which the STB 200 is connected and core routers 12 switching packets in high speed. A protocol independent multicast (PIM) protocol is used between routers, and an Internet group management protocol (IGMP) is used between the edge router 14 and the STB 200. The IGMP is a group management protocol. In IGMPv2, messages include a query message, a membership report message, and a leave report message. Referring to FIG. 4, an IGMPv2 message type includes an 8-bit type, a 16-bit maximum response time, a 16-bit checksum, and a 32-bit group address.

Referring to FIG. 5, a channel change in a multicast is performed when the STB 200 transmits a membership report message to the edge router 14 to participate in a new group. The edge router 14 provides a membership that has participated in the group with audio and video streams. Also, when the STB 200 transmits a leave report message to the edge router 14, a group leave is performed.

A user datagram protocol (UDP), which is a non-connection type and non-reliability protocol, is suitable for a transmission layer protocol of this multicast. The UDP includes an 8-byte header and an 8-byte data. The header includes a 16-bit source port number, a 16-bit destination port number, a 16-bit length, and a 16-bit checksum.

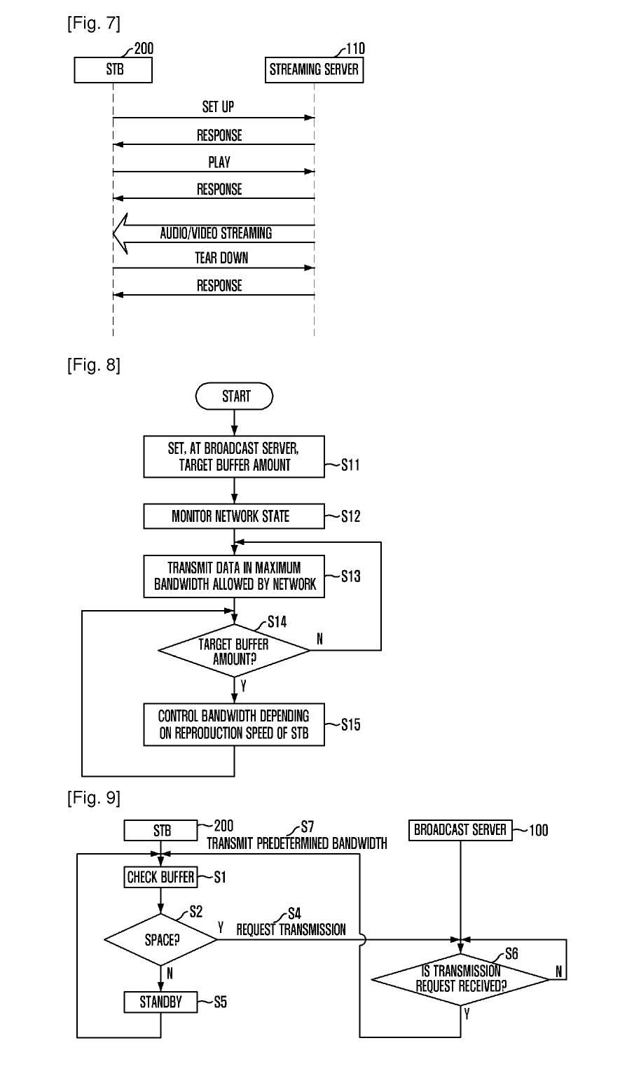

FIG. 6 is a view illustrating an example of a TCP segment primarily used in a unicast, and FIG. 7 is a view illustrating an example of a channel setting procedure according to an RTSP primarily used in a unicast.

In a unicast, there exist a single source and a single destination, and a TCP, which is a protocol having a stream connection orientation and reliability, is used for a transmission layer responsible for delivery between processes. Since the TCP uses a port number as a transmission layer, and a transmission process and a reception process cannot generate and process in the same speed, the TCP uses a buffer for storage. Also, the TCP bundles a plurality of bytes into a group using a packet called a segment, and uses a sequence number and an acknowledge response number for error and flow control. Referring to FIG. 6, the format of a TCP segment includes a header and data of 20-60 bytes. The header includes a 16-bit source port address, a 16-bit destination port address, a 32-bit sequence number, a 32-bit acknowledge response number, a 4-bit header length, a 6-bit control bit (URG, ACK, PSH, RST, SYN, and FIN), a 16-bit window size, a 16-bit checksum, a 16-bit urgent indicator, and an option. The TCP transmits data in a full duplex mode and sets connection using a three-way handshake including SYN, SYN+ACK, and ACK.

Also, a real-time streaming protocol (RTSP) for a TCP streaming process changes a channel through a procedure illustrated in FIG. 7. Referring to FIG. 7, the IPTV STB 200 sets connection to the streaming server 110 with a SET UP message using a relevant meta file, and then send a PLAY message to request an audio/video streaming when receiving a RESPONSE. Then, the streaming server 110 provides corresponding audio/video streaming to allow a media player to reproduce the audio/video stream, and ends connection when a cancel is requested through a TEAR DOWN message.

FIG. 8 is a flowchart of a traffic control method in IPTV broadcast service according to the present invention. A traffic control method in IPTV broadcast service will be described below according to the present invention with reference to FIG. 8.

When the STB 200 accesses the broadcast server 100 to request broadcast reception, the broadcast server 100 sets a target buffer amount, which is a buffer amount allowing the STB 200 to stably reproduce contents without an influence of the network state (S11). At this point, the target buffer amount means a buffer amount that can be secured in advance by the STB 200 so that the STB 200 can reproduce contents without a delay even when a data transmission amount from the broadcast server 100 reduces. The target buffer amount corresponds to a kind of minimum buffer amount for stable reproduction of contents. For example, in the case where a maximum buffer amount that can be secured by the STB 200 is 100%, the target buffer amount can be set to 80% or 90%. The target buffer amount can be set to the maximum value (100%) that can be secured by the STB 200, of course. The target buffer amount can be individually set for each STB 200, or can be collectively set for all of the STBs connected to the broadcast server 100. Also, the target buffer amount can be discriminately set with grades divided in consideration of a network state to which respective STBs 200 are connected and requested contents. Meanwhile, the target buffer amount can be set using statistical data collected in advance depending on the kind and state of a network, and a point (day and time) at which contents are used. These statistical data are data accumulated by empirical values regarding a buffer amount that should be secured for the STB to reproduce contents without a delay depending on the kind and state of a network, and day and time band on which contents are used. Preferably, the statistical data are collected/calculated and managed by the broadcast server 100. In this case, the broadcast server 100 can input a point at which broadcast service is provided and the kind and state of a network to calculate a target buffer amount using statistical data.

The broadcast server 100 monitors a network state and then negotiates with a network to transmit data in a maximum bandwidth (i.e., traffic) allowed by the network (S12 and S13). That is, the broadcast server 100 transmits data as much as possible in the maximum bandwidth within a limit allowed by the network to allow the STB 200 to secure a target buffer amount. Specifically, since the broadcast server 100 transmits a maximum amount of data in the maximum bandwidth, the data transmission amount of the broadcast server is larger than the processing amount of the STB even when the STB 200 processes and reproduces data (contents) transmitted from the broadcast server 100. Accordingly, when a predetermined time elapses, the STB 200 can secure the target buffer amount. Meanwhile, the broadcast server 100 can be configured not to transmit data in the maximum bandwidth but to transmit data greater than an amount processed and reproduced by the STB 200 in operation S13.

The broadcast server 100 checks whether the current buffer amount of the STB 200 has reached the target buffer amount through communication with the STB 200 (S14). In operation S14, the broadcast server 100 can calculate the current buffer amount of the STB 200 with consideration of the transmission bandwidth and transmission time of the broadcast server 100, and the reproduction time of the STB 200. Also, the STB 200 can measure a received buffer amount to inform the broadcast server 100 of the measured buffer amount.

When the current buffer amount of the STB 200 reaches the target buffer amount, data do not need to be transmitted in the maximum bandwidth any more, and the buffer amount of the STB 200 can be maintained to the target buffer amount even when data are transmitted by only an amount processed and reproduced by the STB 200. Therefore, the broadcast server 100 controls the transmission bandwidth (i.e., traffic) according to the reproduction speed of the STB 200 to transmit data by the amount processed and reproduced by the STB 200 (S15). Therefore, since the STB 200 can supplement data by an amount reproduced, it can maintain the target buffer amount. Meanwhile, in operation S15, the broadcast server 100 can calculate the reproduction speed of the STB 200 with consideration of the reproduction time of contents contained in an electronic program guide (EPG). Also, since a trick play may be performed, the broadcast server 100 can request a reproduction speed/amount and a current buffer amount from the STB 200 to obtain them.

After that, the broadcast server 100 continuously checks the buffer amount of the STB 200, and when the current buffer amount of the STB 200 reduces below the target buffer amount, the broadcast server 100 transmits again data in a maximum bandwidth allowed by the network to allow the STB 200 to continuously maintain the target buffer amount. At this point, the broadcast server 100 can check the buffer amount of the STB 200 every predetermined period (time interval), for example, every 10 seconds.

Therefore, even when a network state suddenly deteriorates and the data transmission amount by the broadcast server 100 remarkably reduces, the STB 200 sufficiently buffers data by the target buffer amount set in advance by the broadcast server 100, so that the STB 200 can stably reproduce data (contents) without a delay or suspension of the data. Also, when the network state is recovered later, the broadcast server 100 transmits data in a maximum bandwidth again and the STB 200 recovers the buffer amount by the target buffer amount, so that the STB 200 can stably reproduce contents without an influence of the network state.

While this invention has been particularly shown and described with reference to preferred embodiments thereof, it will be understood by those skilled in the art that the preferred embodiments is considered in descriptive sense only and not for purposes of limitation but various changes in form and details may be made therein without departing from the spirit and scope of the invention as defined by the appended claims.

1. A traffic control method of an Internet protocol television (IPTV) broadcasting service that allows a broadcast server to control a transmission bandwidth depending on a current buffer amount of a set-top box (STB) and variably controls a data transmission amount to allow the current buffer amount of the STB to be maintained to a target buffer amount set by the broadcast server, the method comprising:
setting, at the broadcast server, the target buffer amount of the STB;
monitoring, at the broadcast server, a network state to transmit data to the STB in a maximum bandwidth within a limit allowed by a network;
checking, at the broadcast server, the current buffer amount of the STB; and
when the current buffer amount of the STB reaches the target buffer amount, controlling, at the broadcast server, the transmission bandwidth and reducing the data transmission amount depending on a reproduction speed of the STB.

2. The method of claim 1, wherein the target buffer amount is a buffer amount that should be secured to allow the STB to stably reproduce data (contents) without a delay or suspension without an influence of a change in the data transmission amount from the broadcast server by a change in the network state.

3. The method of claim 1, wherein the checking of the current buffer amount comprises calculating, at the broadcast server, the current buffer amount of the STB using the transmission bandwidth and a transmission time of the broadcast server, and a reproduction time of the STB.

4. The method of claim 1, wherein the controlling of the transmission bandwidth and the reducing of the data transmission amount comprises transmitting, at the broadcast server, data by an amount processed and reproduced by the STB.

5. The method of claim 1, further comprising, after the controlling:
checking, at the broadcast server, the current buffer amount of the STB; and
when the current buffer amount of the STB reduces below the target buffer amount, transmitting, at the broadcast server, data in a maximum bandwidth within a limit allowed by the network.
